(19) United States
(12) Patent Application Publication
(10) Pub. No.: US 2015/0307064 A1
(43) Pub. Date: Oct. 29, 2015

(54) WINDSHIELD WIPER RENEWAL STRIP

(71) Applicant: Peter B. Aronow, East Hampton, NY (US)

(72) Inventor: Peter B. Aronow, East Hampton, NY (US)

(21) Appl. No.: 14/686,281

(22) Filed: Apr. 14, 2015

Related U.S. Application Data
(60) Provisional application No. 61/985,499, filed on Apr. 29, 2014.

(51) Int. Cl. B60S 1/04; B24D 11/00

(52) U.S. Cl. CPC B60S 1/0486; B60S 1/0477; B24D 11/00; B60S 2001/3846

(57) ABSTRACT

A device can be applied upon or included into a windshield that has an abrasive exterior surface. The device can be applied to the windshield at a location over which the windshield wiper will pass, thereby causing the abrasive exterior of the device to contact the wiper blade, cleaning, repairing, restoring, refinishing and re-sharpening the wiping surface of the wiper blade to provide an even and clean squeegee action as the wiper passes over the windshield.

### CROSS-REFERENCE TO RELATED APPLICATION

This application claims the benefit of priority of U.S. provisional application No. 61/985,49, the contents of which are herein incorporated by reference.

### BACKGROUND OF THE INVENTION

The present invention relates to automotive accessories and, more particularly, to an abrasive strip that can be applied to an exterior of a windshield to permit a windshield wiper blade to pass thereover to clean, renew and restore the windshield wiper blade.

Windshield wiper blades operate by passing a flexible strip of material, such as rubber, or the like, over a windshield surface, thereby cleaning the surface of the windshield via a squeegee action. However, if a particle gets stuck onto the windshield wiper blade, the boundary between the blade and the windshield surface is no longer smooth and squeegee action of the wiper on the windshield surface can streak as it passes.

Moreover, buildup of dirt, oxidation, fine debris, pollen and the like, on a wiper blade and negatively affect the ability of the wiper to smoothly pass along the windshield surface.

Also, as a windshield wiper ages, the blade becomes less and less effective from dirt, wear, cracks and chips. Even a wiper blade of limited age can be seen to be extremely dirty, as just running a finger along the blade can turn one's finger black with dirt. Not only does this reduce the ability of the wiper blade to clean the windshield, the wiper can also become noisy while being operated.

To overcome these issues, wiper cleaners are used. These cleaners, however, require the user to manually clean the wiper blade, often with a rag and a solvent, for example. This, however, may not be done, as, when a user is reminded to clean the wiper blades (via operation of the windshield wipers), the weather is usually not suited for working on the wiper blades. Therefore, the problem often continues to worsen over time.

As can be seen, there is a need for a device that can effectively and easily clean the wiper blades without requiring additional work of the user.

### SUMMARY OF THE INVENTION

In one aspect of the present invention, a method for treating a blade operating on a glass surface comprises passing the blade over an abrasive strip affixed to the glass surface; and contacting a wiping edge of the blade with the abrasive strip to repair, restore, refinish, re-sharpen and remove foreign substances therefrom.

In another aspect of the present invention, a method for treating a wiper blade on a windshield of a vehicle comprises passing the wiper blade over an abrasive strip attached to the windshield during operation of the wiper blade of the vehicle; and contacting a wiping edge of the wiper blade with the abrasive strip to repair, restore, refinish, re-sharpen and remove foreign substances therefrom.

These and other features, aspects and advantages of the present invention will become better understood with reference to the following drawings, description and claims.

### BRIEF DESCRIPTION OF THE DRAWINGS

FIG. 1 is a perspective view of a windshield having a wiper renewal system according to an exemplary embodiment of the present invention;

FIG. 2 is a perspective view of a windshield having a wiper renewal system according to another exemplary embodiment of the present invention; and

FIG. 3 is a perspective view of a windshield having a wiper renewal system according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device that can be applied upon or included into a windshield that has an abrasive exterior surface. The device can be applied to the windshield at a location over which the windshield wiper will pass, thereby causing the abrasive exterior to contact the wiper blade, cleaning the wiping surface of the wiper blade to provide an even and clean squeegee action as the wiper passes over the windshield.

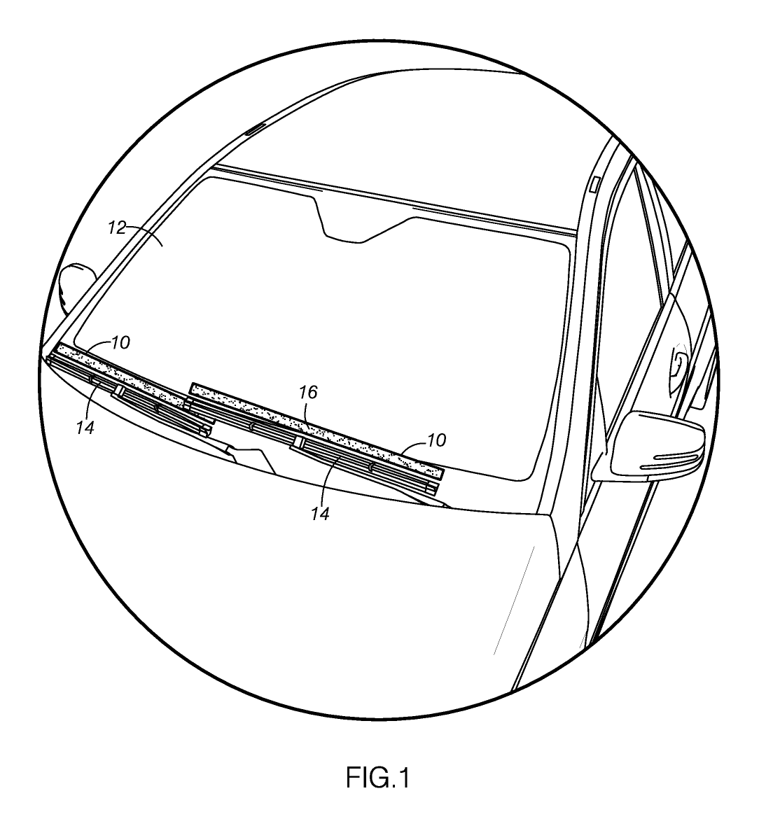

Referring to FIG. 1, an abrasive strip 10 can be applied to a windshield 12 at a location through which a wiper blade 14 of a windshield wiper passes. The abrasive strip 10 can include, on its exterior side, a surface 16 that may clean and/or renew the wiper blade 14. Further details of this surface are described below.

The abrasive strip 10 can attach to the windshield 12 by various manners, such as with an adhesive pre-applied to the strip, with a glue, by film coating, by a cling adhesion, or the like.

The strip 10 may be made of various materials, such as paper, plastic, rubber, textile, or the like, or combinations thereof. In some embodiments, the strip 10 may be applied in liquid form to the windshield 14, forming the strip 10 as the liquid dries. In this embodiment, the liquid may have a substance (such as sand alumina, or the like) that may create an abrasive surface when the liquid dries. The liquid may have a sufficient viscosity such that the liquid will not run down and/or off the windshield upon application thereto and will stay in place while the liquid dries.

In some vehicles, while the windshield wipers are in continuous use, they may or may not pass over the abrasive strip 10, however, when the wipers are turned off, the wiper blades 14 may be disposed/stored at a lower position lower than the lowest position the wiper blades 14 reach while operating. In this case, the abrasive strip 10 may be disposed so that the wipers pass over the abrasive only when the wiper blades 14 are turned on or off and not while in continuous operation.

In some vehicles, the wiper blades 14 may move to their lowest point, even during operation. In this embodiment, the wiper blades 14 may pass over the abrasive strip 10 during each wipe of the windshield 12.

In either case, the wiper blades 14 pass over the abrasive strip 14, cleaning the wiper blade 14 and improving their effectiveness.

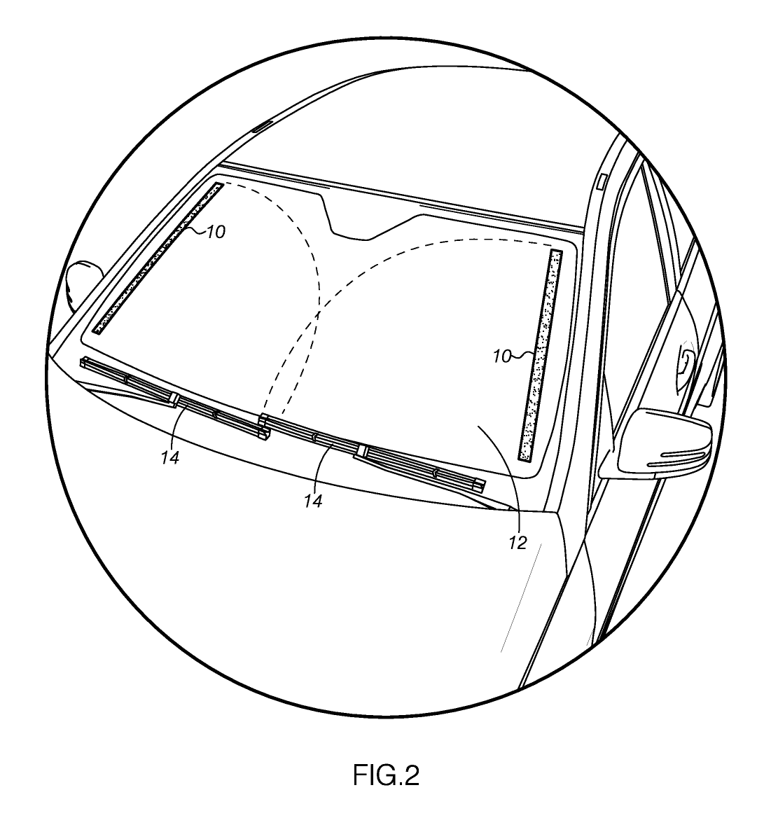

In still other embodiments, the abrasive strip 10 may be applied at a maximum stroke position of the wiper blade 14. This embodiment may be most suitable for single wiper blades or opposed wiper blades, where the maximum stroke position may be along a side of a windshield 14, for example, as shown in FIG. 2.

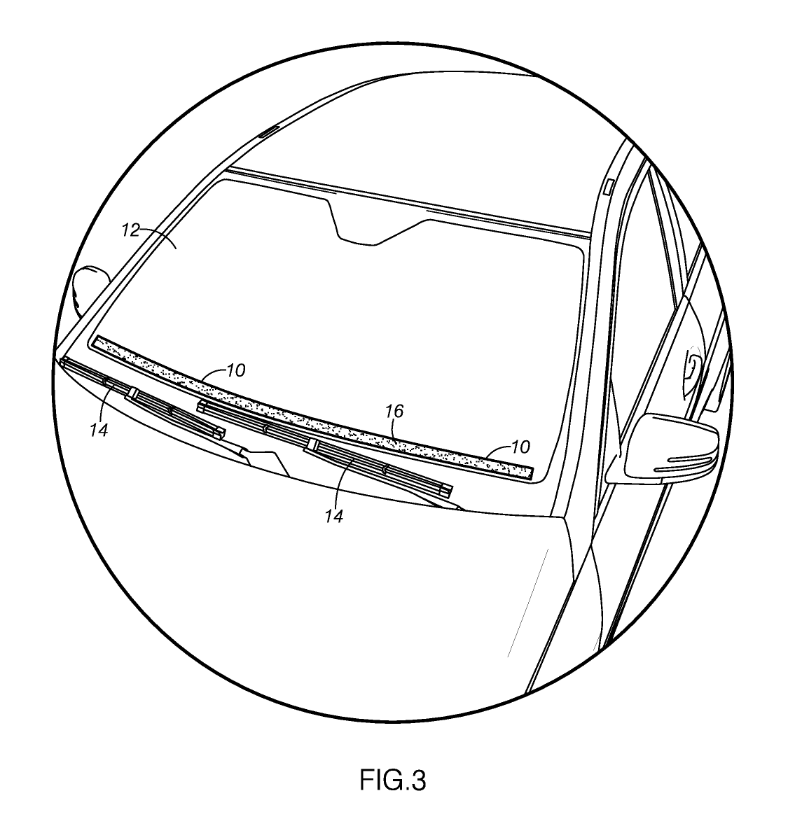

Typically, the abrasive strip 10 may be provided in a length equal to or slightly longer than the wiper blade 14. In some embodiments, as shown in FIG. 3, the abrasive strip 10 may extend substantially along the entire length of the windshield 12. The abrasive strip 10 may typically be formed from a clear material, but may also be disposed in tinted, colored or opaque materials. The abrasive exterior of the abrasive strip may have an abrasive grit suitable for cleaning wiper blades 14, typically from about 1400 grit to 40 grit, for example. An adhesive may be suitable for securing the product to a windshield and may be weatherproof so rain, snow and the like does not release the adhesive. The abrasive material may be selected from various particles, including silica, alumina, quartz, stone, plastic, and the like.

The abrasive adhesive of the present invention may be used on any vehicle having a windshield. This can include a front windshield or a rear window, for example. In addition, the abrasive adhesive may be useful for window washers, where the abrasive adhesive may be applied to one or more windows to allow a window washer to pass their squeegee thereover, thus cleaning the squeegee blade.

It should be understood, of course, that the foregoing relates to exemplary embodiments of the invention and that modifications may be made without departing from the spirit and scope of the invention as set forth in the following claims.

What is claimed is:

1. A method for treating a blade operating on a glass surface, the method comprising:
passing the blade over an abrasive strip affixed to the glass surface; and
contacting a wiping edge of the blade with the abrasive strip to repair, restore, refinish, re-sharpen and remove foreign substances therefrom.

2. The method of claim 1, further comprising attaching the abrasive strip to the glass surface with at least one of a pressure sensitive adhesive, a glue, a cling attachment, and a film coating attachment.

3. The method of claim 1, wherein the glass surface is a vehicle windshield and the blade is at least one wiper blade.

4. The method of claim 1, wherein the abrasive strip has an abrasive rating from about 1400 grit to about 40 grit.

5. The method of claim 1, wherein the blade is a squeegee.

6. A method for treating a wiper blade on a windshield of a vehicle, comprising:
passing the wiper blade over an abrasive strip attached to the windshield during operation of the wiper blade of the vehicle; and
contacting a wiping edge of the wiper blade with the abrasive strip to repair, restore, refinish, re-sharpen and remove foreign substances therefrom.

7. The method of claim 6, further comprising:
attaching the abrasive strip to the windshield at a location over which the wiper blade passes during operation thereof.

8. The method of claim 7, wherein the abrasive strip is attached to the glass surface with at least one of a pressure sensitive adhesive, a glue, a cling attachment, and a film coating attachment.

9. The method of claim 6, wherein the abrasive strip has an abrasive rating from about 1400 grit to about 40 grit.

10. The method of claim 6, wherein the abrasive strip is applied to the windshield as a mixture of an adhesive liquid and a grit forming material, wherein the adhesive liquid dries to adhere the grit forming material to the windshield.

11. The method of claim 6, wherein a first abrasive strip is applied to the windshield for a first wiper blade and a second abrasive strip is applied to the windshield for a second wiper blade.

12. The method of claim 6, wherein multiple ones of the abrasive strip is provided for each wiper blade of the vehicle.

13. The method of claim 6, wherein a single abrasive strip is applied to the windshield for each of the wiper blades of the vehicle.
